(19) United States
(12) Patent Application Publication
(10) Pub. No.: US 2010/0237926 A1
(43) Pub. Date: Sep. 23, 2010

(54) VOLTAGE GENERATING CIRCUIT

(75) Inventors: Hiroyuki Kikuta, Kyoto (JP); Yuichi Ohkubo, Gunma (JP); Kazuyoshi Asakawa, Tokyo (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI SEMICONDUCTOR CO., LTD., Tokyo (JP)

(21) Appl. No.: 12/724,518

(22) Filed: Mar. 16, 2010

(30) Foreign Application Priority Data
Mar. 19, 2009 (JP) 2009-067884

(51) Int. Cl. G06G 7/14

(52) U.S. Cl. 327/361

(57) ABSTRACT

A voltage generating circuit including first and second voltage sources, and a subtracting circuit. The subtraction circuit is configured as a differential amplifier including an op-amp and four resistors, with an inverting input terminal of the op-amp connected to the second voltage source via a first resistor, a second resistor connected between the inverting input terminal and an output terminal of the op-amp, a non-inverting input terminal of the op-amp connected to the first voltage source via a third resistor of the same size as the second resistor, the non-inverting input terminal of the op-amp connected to a reference potential terminal via a fourth resistor of the same size as the first resistor, the first voltage from the first voltage source and the second voltage from the second voltage source inputted to the subtracting circuit, and the subtracting circuit outputting a third voltage having a positive temperature coefficient.

### CROSS-REFERENCE TO RELATED APPLICATION

This application is based on and claims priority under 35 USC 119 from Japanese Patent Application No. 2009-067884 filed on Mar. 19, 2009, the disclosure of which is incorporated by reference herein.

### BACKGROUND

1. Technical Field

The present invention relates to a voltage generating circuit.

2. Related Art

Conventionally, a temperature detecting circuit is disposed inside a semiconductor integrated circuit for purposes such as preventing the destruction of the semiconductor integrated circuit by a temperature rise. The temperature detecting circuit is configured from a PTAT voltage generating circuit that generates a proportional-to-absolute-temperature (PTAT) voltage, a reference voltage generating circuit that generates a reference voltage, and a comparing circuit that compares the outputs of the PTAT voltage generating circuit and the reference voltage generating circuit. The reference voltage is set beforehand in accordance with the PTAT voltage at a temperature T at which the semiconductor integrated circuit is operable. When the temperature rises and the PTAT voltage exceeds the reference voltage, the comparing circuit generates a signal that controls the operation of the semiconductor integrated circuit (Japanese Patent Application Laid-Open (JP-A) Nos. 11-103108 and 11-213644).

Recently, as a temperature detecting circuit that is capable of high-precision temperature detection, there has been proposed a temperature detecting circuit that applies the “principle of a work function of a gate” (JP-A No. 2004-239734). This temperature detecting circuit is, as shown in FIG. 6, configured from a first voltage source circuit that outputs a voltage having a positive or negative temperature coefficient, a second voltage source circuit that outputs a reference voltage not having a temperature coefficient, a subtracting circuit that performs subtraction with the output voltage having a positive or negative temperature coefficient from the first voltage source circuit and the reference voltage not having a temperature coefficient from the second voltage source circuit, and a comparing circuit that compares the output voltage from the subtracting circuit and the reference voltage not having a temperature coefficient from the second voltage source circuit.

Svptat, which is a PTAT voltage having a positive or negative temperature coefficient, is applied from the first voltage source circuit to a positive input terminal of the subtracting circuit. Further, a reference voltage Svref that does not have a temperature coefficient and is generated by the second voltage source circuit is applied to a negative input terminal of the subtracting circuit. The subtracting circuit is configured by an op-amp OP2 and resistors R7, R8, R9 and R10. This op-amp OP2 is used as a differential amplifier, and the general rule is that the op-amp OP2 is operated under the condition that R7=R9 and R8=R10. Consequently, an output voltage (that is, the output of the subtracting circuit) Tvptat of the op-amp OP2 is expressed simply by expression (1) below as being equal to the product of the resistance ratio (R8/R7) and the differential input (Svptat−Svref).

Tvptat=(R8/R7)*(Svptat−Svref) Expression (1)

Further, as shown in FIG. 6, the comparing circuit is configured by an op-amp OP3. A reference voltage Vref that does not have a temperature coefficient and is generated by the second voltage source circuit is converted into Tvref by the resistors R4, R5 and R6. This voltage Tvref is applied to an inverting input terminal of the comparing circuit, and the output Tvptat of the subtracting circuit is applied to a non-inverting input terminal of the comparing circuit. Consequently, when the temperature is lower than a set temperature T, Tvref<Tvptat, and an output Tout of the comparator becomes a high level (H). On the other hand, when the temperature becomes higher than the set temperature T, Tvref>Tvptat, and the output Tout of the comparator becomes a low level (L).

However, in the temperature detecting circuit shown in FIG. 6, because the reference voltage Svref does not have a temperature coefficient, as will be understood from expression (1) above, the maximum temperature coefficient of the output Tvptat of the subtracting circuit is dependent on only the temperature coefficient of Svptat, which is a PTAT voltage. Thus, in this circuit configuration, the temperature coefficient cannot be sufficiently reflected in the output of the subtracting circuit. Further, the output Tvptat of the subtracting circuit is, as shown in expression (1) above, dependent on only the temperature coefficient of Svptat. Thus, the output voltages Vptat, Vptat′ and Svptat of the first voltage source circuit are affected by variations in a threshold voltage resulting from the process factor of an n-channel field effect transistor M2, so the output voltage of the subtracting circuit also ends up being similarly affected. Further, as long as it is dependent on only the temperature coefficient of Svptat, the output voltage of the subtracting circuit does not become an arbitrary value.

### SUMMARY

The present invention has been made in order to address the above-described problem, and it is an object of the present invention to provide a voltage generating circuit that can output a voltage having a positive temperature coefficient and can arbitrarily set a positive temperature coefficient.

In order to achieve the above-described object, the present invention is characterized in that it is equipped with the following configuration.

A first aspect of the present invention provides a voltage generating circuit including:

a first voltage source that outputs a first voltage having a positive temperature coefficient;

a second voltage source that outputs a second voltage having a negative temperature coefficient; and

a subtracting circuit that is configured as a differential amplifier including an op-amp and four resistors, with an inverting input terminal of the op-amp being connected to the second voltage source via a first resistor, a second resistor being connected between the inverting input terminal and an output terminal of the op-amp, a non-inverting input terminal of the op-amp being connected to the first voltage source via a third resistor of the same size as the second resistor, the non-inverting input terminal of the op-amp being connected to a reference potential terminal via a fourth resistor of the same size as the first resistor, the first voltage from the first voltage source and the second voltage from the second voltage source being inputted to the subtracting circuit, and the subtracting circuit outputting a third voltage having a positive temperature coefficient.

A second aspect of the present invention provides the voltage generating circuit according to the first aspect, wherein the first resistor, the second resistor, the third resistor and the fourth resistor are variable resistors, and weightings of the first voltage and the second voltage inputted to the subtracting circuit are different.

A third aspect of the present invention provides the voltage generating circuit according to the first aspect, wherein the reference potential terminal is a ground terminal or a constant potential terminal.

A fourth aspect of the present invention provides the voltage generating circuit according to the first aspect, wherein

the first voltage source is configured by a voltage source circuit that outputs a voltage having a positive temperature coefficient proportional to a thermal voltage or by another voltage source circuit that outputs a voltage expressed by a sum of a forward voltage of a diode and the voltage having the positive temperature coefficient proportional to the thermal voltage, and

the second voltage source is configured by a voltage source circuit that is equipped with a diode connection and outputs a voltage having a negative temperature coefficient generated by the diode.

According to the aspects of the invention described above, there are the following effects.

According to the first aspect of the invention, there is the effect that there can be provided a voltage generating circuit that can output a voltage having a positive temperature coefficient and can arbitrarily set a positive temperature coefficient.

According to the second aspect of the invention, there is the effect that weightings of the voltage having a positive temperature coefficient and the voltage having a negative temperature coefficient can be changed and the value of the output voltage can be arbitrarily set such that the output voltage rises from 0 V in proportion to temperature.

According to the third aspect of the invention, there is the effect that, when connected to a constant potential terminal of a reference voltage, there can be obtained an output voltage that is equal to the sum of an output voltage when connected to a ground terminal and a constant voltage proportional to the reference voltage, and the value of the output voltage can be arbitrarily set while maintaining the positive temperature coefficient of the output voltage.

According to the fourth aspect of the invention, there is the effect that the first voltage source and the second voltage source can be configured by voltage source circuits that are capable of arbitrarily setting the temperature coefficients of the voltages they generate. In particular, there is the effect that, when the first voltage source is configured by a voltage source circuit that outputs a voltage having a positive temperature coefficient proportional to a thermal voltage, the output voltage is not affected by the process factor of a diode in comparison to when the first voltage source is configured by a voltage source circuit that outputs a voltage expressed by the sum of a forward voltage of a diode and a voltage having a positive temperature coefficient proportional to a thermal voltage.

### BRIEF DESCRIPTION OF THE DRAWINGS

Exemplary embodiments of the present invention will be described in detail based on the following figures, wherein:

FIG. 1 is a general block diagram showing the basic configuration of a voltage generating circuit of the present invention;

FIG. 2 is a circuit diagram showing the configuration of a voltage generating circuit pertaining to a first exemplary embodiment of the present invention;

FIG. 3 is a circuit diagram showing the configuration of a voltage generating circuit pertaining to a second exemplary embodiment of the present invention;

FIG. 4 is a circuit diagram showing the configuration of a voltage generating circuit pertaining to a third exemplary embodiment of the present invention;

FIG. 5 is a circuit diagram showing the configuration of a voltage generating circuit pertaining to a fourth exemplary embodiment of the present invention;

FIG. 6 is a circuit diagram showing the configuration of a temperature detecting circuit pertaining to conventional technology; and

FIG. 7 is a graph showing temperature characteristics of signals of the voltage generating circuit.

### DETAILED DESCRIPTION

Exemplary embodiments of the present invention will be described in detail below with reference to the drawings.

<Basic Configuration>

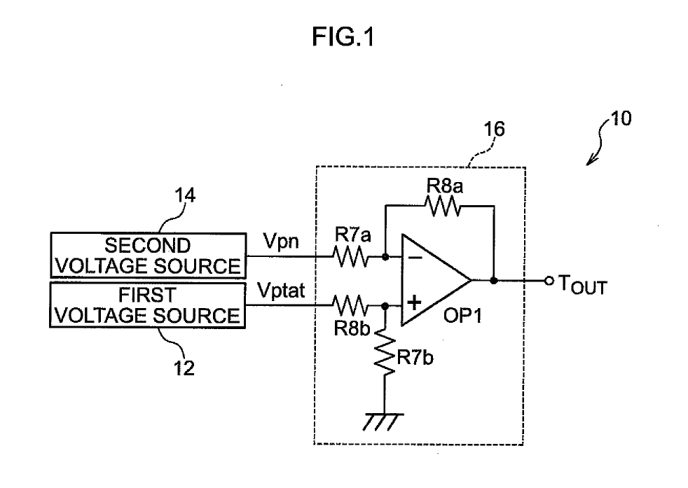

FIG. 1 is a general block diagram showing the basic configuration of a voltage generating circuit 10 of the present invention.

As shown in FIG. 1, the voltage generating circuit 10 of the present invention is equipped with a first voltage source 12 that outputs a voltage Vptat having a positive temperature coefficient, a second voltage source 14 that outputs a voltage Vpn having a negative temperature coefficient, and a subtracting circuit 16 into which the voltage Vptat from the first voltage source 12 and the voltage Vpn from the second voltage source 14 are inputted and which outputs a voltage Tout having a positive temperature coefficient.

The subtracting circuit 16 is configured as a differential amplifier including an op-amp OP1 and four resistors. An inverting input terminal (−) of the op-amp OP1 is connected to the second voltage source 14 via a first resistor R7a. A second resistor R8a is connected between the inverting input terminal (−) and an output terminal of the op-amp OP1.

A non-inverting input terminal (+) of the op-amp OP1 is connected to a first voltage source 12 via a third resistor R8b of the same size as the second resistor R8a. The non-inverting input terminal (+) of the op-amp OP1 is connected to a reference potential terminal via a fourth resistor R7b of the same size as the first resistor R7a. The reference potential terminal includes a ground terminal (reference potential=0 V).

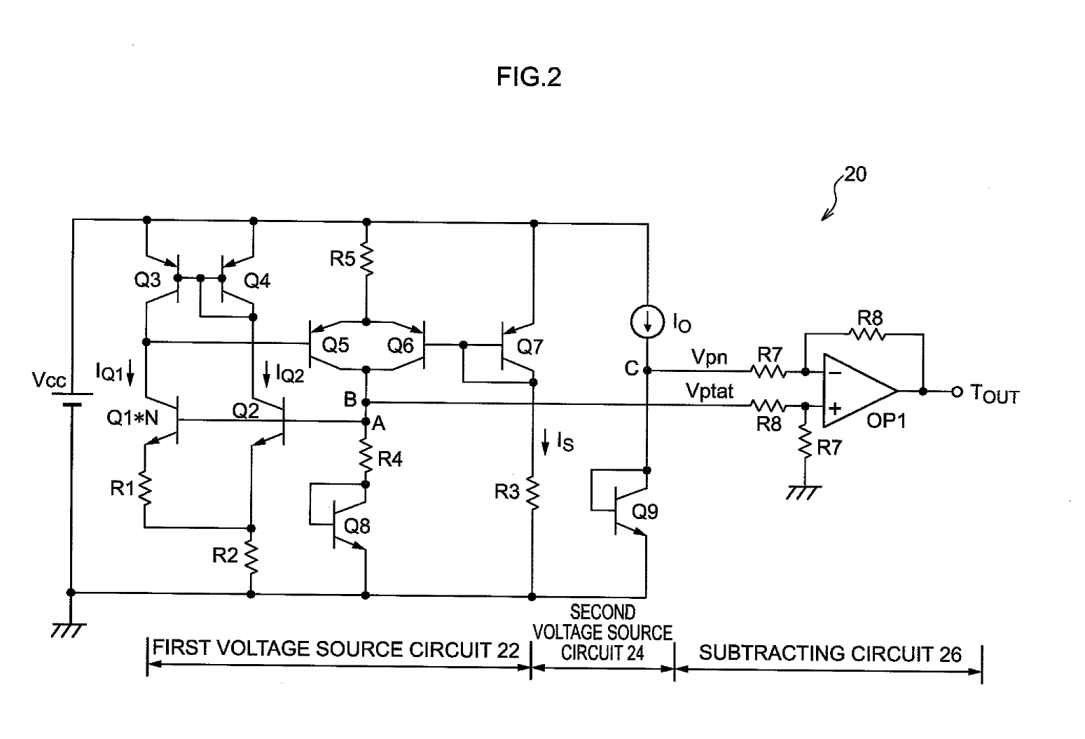

The first resistor R7a and the fourth resistor R7b are different resistors, but their resistance values are the same size, so in FIG. 2 to FIG. 5, the first resistor R7a and the fourth resistor R7b are indicated simply as “R7”. Similarly, the second resistor R8a and the third resistor R8b are indicated simply as “R8”.

Next, the circuit operation of the voltage generating circuit 10 will be described. In the voltage generating circuit 10, the voltage Vptat having a positive temperature coefficient that is outputted from the first voltage source 12 is inputted to the non-inverting input terminal (+) of the op-amp OP1 of the subtracting circuit 16. Further, the voltage Vpn having a negative temperature coefficient that is outputted from the second voltage source 14 is inputted to the inverting input terminal (−) of the op-amp OP1 of the subtracting circuit 16.

Here, the op-amp OP1 is an ideal op-amp, and assuming that the input impedance is infinite (∞), the area between the first voltage source 12 and the non-inverting input terminal (+) and the area between the second voltage source 14 and the inverting input terminal (−) can be regarded as virtual shorts. When the output voltage Tout of the op-amp OP1 is calculated under the condition of R7a=R7b=R7 and R8a=R8b=R8, as expressed by expression (2) below, the output voltage Tout becomes a value that is equal to the difference between the voltage Vptat having a positive temperature coefficient and the product of the resistance ratio (R8/R7) and the voltage Vpn having a negative temperature coefficient.

Tout=Vptat−(R8/R7)*Vpn Expression (2)

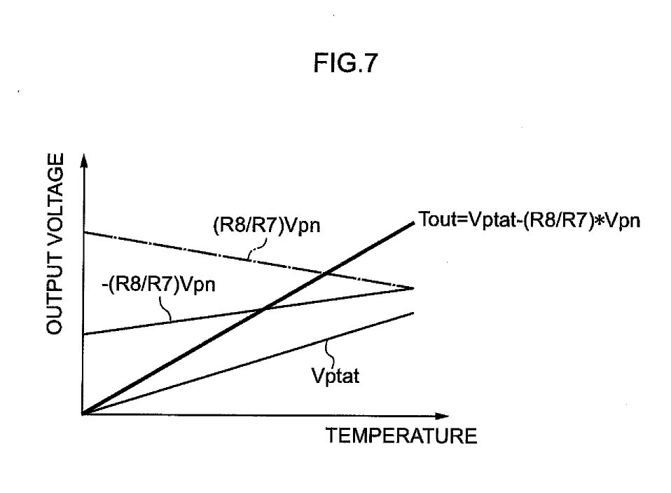

FIG. 7 is a graph showing temperature characteristics of signals of the voltage generating circuit 10 of the present invention. As will be understood from this graph, the sign of the negative temperature coefficient of the voltage Vpn reverses because of subtraction, the absolute value of the temperature coefficient of the voltage Vpn is added to the positive temperature coefficient of the voltage Vptat, and the voltage Tout having a positive temperature coefficient is outputted.

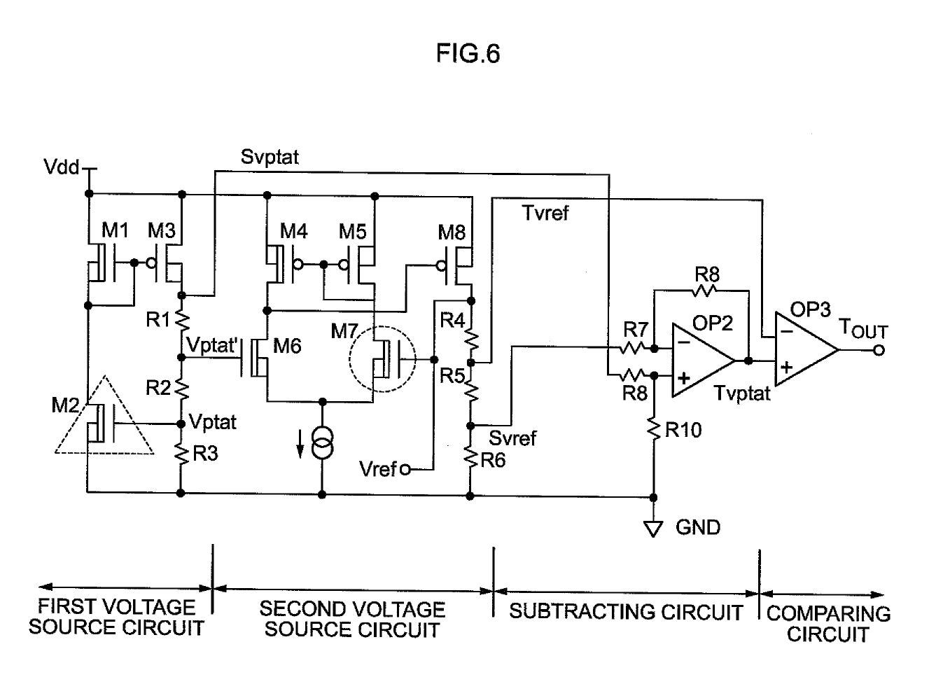

As was shown in expression (1) above, when compared with the temperature detecting circuit shown in FIG. 6 where the output of the subtracting circuit was dependent on only the temperature coefficient of the voltage Svptat, the output of the subtracting circuit 16 is dependent on the temperature coefficients of each of the two types of input voltages Vptat and Vpn. Consequently, the positive temperature coefficient of the output voltage Tout can be arbitrarily set by adjusting the temperature coefficients of the input voltages Vptat and Vpn. Further, the value of the output voltage Tout can be arbitrarily set by adjusting the resistance ratio (R8/R7). For example, even when Vptat Vpn, the resistance ratio (R8/R7) can be adjusted such that the output voltage rises from 0 V in proportion to temperature.

### First Exemplary Embodiment

### (Configuration of Voltage Generating Circuit)

FIG. 2 is a circuit diagram showing the configuration of a voltage generating circuit 20 pertaining to a first exemplary embodiment of the present invention.

The voltage generating circuit 20 pertaining to the first exemplary embodiment is equipped with a first voltage source circuit 22 that outputs a voltage having a positive temperature coefficient, a second voltage source circuit 24 that outputs a voltage having a negative temperature coefficient, and a subtracting circuit 26 into which a voltage Vptat from the first voltage source circuit 22 and a voltage Vpn from the second voltage source circuit 24 are inputted and which outputs a voltage Tout having a positive temperature coefficient. In the present exemplary embodiment, the first voltage source circuit 22 corresponds to a “first voltage source” and the second voltage source circuit 24 corresponds to a “second voltage source”.

The configuration of the subtracting circuit 26 is the same as that of the subtracting circuit 16 pertaining to the basic configuration, so the same signs will be given to the same configural portions and description will be omitted. In the present exemplary embodiment, the reference voltage terminal is a ground terminal, and one end of the fourth resistor R7b is grounded. Further, in the exemplary embodiment below, a case where the voltage generating circuit is configured using plural bipolar transistors will be described. The plural bipolar transistors are formed monolithically on the same semiconductor substrate. The bipolar transistors will be simply called “transistors” below.

The first voltage source circuit 22 is configured to be equipped with an NPN transistor Q1, an NPN transistor Q2, a PNP transistor Q3, a PNP transistor Q4, a PNP transistor Q5, a PNP transistor Q6, a PNP transistor Q7, an NPN transistor Q8, a resistor R1, a resistor R2, a resistor R3, a resistor R4 and a resistor R5.

The base and the collector of the transistor Q7 are connected (diode-connected). The base of the transistor Q6 and the base of the transistor Q7 are common-connected to configure a current mirror circuit. One end of the resistor R3 is connected to the collector side of the transistor Q7. The other end of the resistor R3 is grounded. One end of the resistor R5 is connected to the emitter side of the transistor Q6. The other end of the resistor R5 is connected to a power source Vcc. The transistor Q6, the transistor Q7, the resistor R3 and the resistor R5 configure a “starting circuit” that starts operation because of the application of a power source voltage.

The transistor Q1 and the transistor Q2 are a pair of transistors whose current densities are different. The base of the transistor Q1 and the base of the transistor Q2 are common-connected. One end of the resistor R2 is connected to the emitter side of the transistor Q2. The other end of the resistor R2 is grounded. The resistor R1 is connected between the connection point where the emitter of the transistor Q2 and the resistor R2 are connected and the emitter of the transistor Q1.

The base of the transistor Q3 and the base of the diode-connected transistor Q4 are common-connected to configure a current mirror circuit such that a collector current I_{Q1} of the transistor Q1 and a collector current I_{Q2} of the transistor Q2 become equal. The base of the output-use transistor Q5 is connected to the connection point where the collector of the transistor Q3 and the collector of the transistor Q1 are connected.

One end of the resistor R5 is connected to the emitter side of the transistor Q5. The other end of the resistor R5 is connected to the power source Vcc. The resistor R4 and the diode-connected transistor Q8 are connected in series as loads to the collector side of the transistor Q5. The emitter side of the transistor Q8 is grounded. The base of the transistor Q1 and the base of the transistor Q2 are common-connected to a connection point A where the collector of the transistor Q5 and the resistor R4 are connected.

The transistor Q1, the transistor Q2, the transistor Q3, the transistor Q4, the transistor Q5, the transistor Q8, the resistor R1, the resistor R2, the resistor R4 and the resistor R5 configure a “band-gap reference circuit” that generates a voltage having an arbitrary temperature characteristic. The voltage Vptat having a positive temperature coefficient is outputted from a connection point B located between the connection point A and the collector of the transistor Q5. The voltage Vptat is inputted to the non-inverting input terminal (+) of the op-amp OP1 of the subtracting circuit 26.

The second voltage source circuit 24 is equipped with a current source I₀ that is an active load and a diode-connected transistor Q9. The current source I₀ is connected to the collector side of the transistor Q9. The emitter of the transistor Q9 is grounded. The voltage Vpn having a negative temperature coefficient is outputted from a connection point C located between the current source I₀ and the collector of the transistor Q9. The voltage Vpn is inputted to the inverting input terminal (−) of the op-amp OP1 of the subtracting circuit 26.

### (Operation of Voltage Generating Circuit)

Next, the circuit operation of the voltage generating circuit 20 will be described.

First, when a voltage is applied to the power source Vcc, the voltage is applied to the resistor R3 via the transistor Q7 and a slight current I_{S} flows between the transistor Q7 and the resistor R3. The current I_{S} flows in the diode-connected transistor Q8 via the resistor R4 because of the current mirror circuit configured by the transistors Q6 and Q7. When the current flows in the transistor Q8, the base-emitter voltage of the diode-connected transistor Q8 is applied to the base terminals of the transistor Q2 and the transistor Q1.

Thus, the transistor Q1 and the transistor Q2 both operate and the collector current I_{Q1} and the collector current I_{Q2} flow. Here, by making the transistor size of the transistor Q1 larger (N times) than that of the transistor Q2, the collector current I_{Q1}>the collector current I_{Q2}. Because the value of the collector current I_{Q1} is large, the base current of the transistor Q5 is pulled, the transistor Q5 operates, and the collector current of the transistor Q5 flows.

When the value of the collector current I_{Q1} is sufficiently large, the collector current of the transistor Q5 becomes large, the voltage drop in the resistor R5 can no longer be ignored, and the transistor Q6 no longer operates. By stopping the operation of the transistor Q6, the transistor Q6 enters a cutoff state where the current does not flow to the collector, and the first voltage source circuit 22 comes to operate stably.

The collector currents of the transistors Q1 and Q2 of the first voltage source circuit 22 that has come to operate stably become such that the collector current I_{Q1}=the collector current I_{Q2} because of the current mirror circuit of the transistors Q3 and Q4. 2I_{Q1}, which is the sum of these collector currents, flows in the resistor R2. The connection point B, the connection point A and the base of the transistor Q2 are all the same potential.

Consequently, the output voltage Vptat from the connection point B becomes the sum of the drop voltage when 2I_{Q1} flows in the resistor R2 and the base-emitter voltage of the transistor Q2. That is, the output voltage Vptat becomes a voltage having a positive temperature coefficient overall and is expressed by the sum of a forward voltage of a diode and a voltage having a positive temperature coefficient proportional to thermal voltage expressed by kT/q (where k is the Boltzmann constant, T is absolute temperature, and q is electronic charge amount).

Next, in the second voltage source circuit 24, a current flows from the current source L to the transistor Q9. The transistor Q9 is diode-connected, so the base-emitter voltage has a negative temperature coefficient. The base-emitter voltage of the transistor Q9 is outputted from the connection point C as the output voltage Vpn having a negative temperature coefficient.

Next, in the subtracting circuit 26, the voltage Vptat having a positive temperature coefficient is inputted to the non-inverting input terminal (+) of the op-amp OP1. Further, the voltage Vpn having a negative temperature coefficient is inputted to the inverting input terminal (−) of the op-amp OP1. In accordance with expression (2) above, the output voltage Tout becomes a value that is equal to the difference between the voltage Vptat and the product of the resistance ratio (R8/R7) and the voltage Vpn.

As described above, in the voltage generating circuit 20 of the present exemplary embodiment, the positive temperature coefficient of the output voltage Tout can be arbitrarily set by adjusting the temperature coefficients of the input voltages Vptat and Vpn. Further, the value of the output voltage Tout can be arbitrarily set by adjusting the resistance ratio (R8/R7) such that the output voltage rises from 0 V in proportion to temperature.

### Second Exemplary Embodiment

### (Configuration of Voltage Generating Circuit)

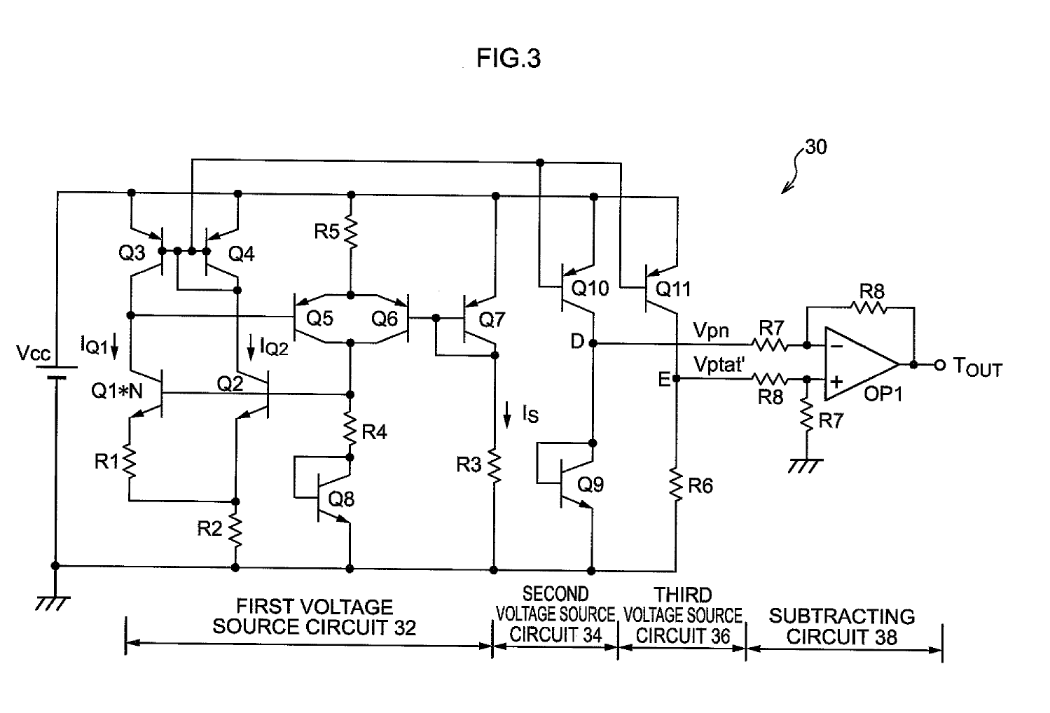

FIG. 3 is a circuit diagram showing the configuration of a voltage generating circuit 30 pertaining to a second exemplary embodiment of the present invention.

The voltage generating circuit 30 pertaining to the second exemplary embodiment is equipped with a first voltage source circuit 32 for generating a voltage having a positive temperature coefficient, a second voltage source circuit 34 that outputs a voltage having a negative temperature coefficient, a third voltage source circuit 36 that outputs a voltage having a positive temperature coefficient, and a subtracting circuit 38 into which a voltage Vptat from the third voltage source circuit 36 and a voltage Vpn from the second voltage source circuit 34 are inputted and which outputs a voltage Tout having a positive temperature coefficient. In the present exemplary embodiment, the first voltage source circuit 32 and the third voltage source circuit 36 correspond to a “first voltage source” and the second voltage source circuit 34 corresponds to a “second voltage source”.

The voltage generating circuit 30 pertaining to the second exemplary embodiment has substantially the same configuration as that of the voltage generating circuit 20 pertaining to the first exemplary embodiment except that the third voltage source circuit 36 is added and the circuit configuration is changed because the third voltage source circuit 36 is added, so the same signs will be given to the same configural portions and some description will be omitted.

The second voltage source circuit 34 uses a PNP transistor Q10 instead of the current source I₀ of the second voltage source circuit 24 of the first exemplary embodiment. The diode-connected transistor Q9 is connected to the collector side of the transistor Q10. The base of the transistor Q10 is common-connected to the bases of the transistors Q3 and Q4 of the first voltage source circuit 32. The voltage Vpn having a negative temperature coefficient is outputted from a connection point D located between the collector of the transistor Q10 and the collector of the transistor Q9. The voltage Vpn is inputted to the inverting input terminal (−) of the op-amp OP1 of the subtracting circuit 38.

The third voltage source circuit 36 is configured to be equipped with a PNP transistor Q11 and a resistor R6. One end of the resistor R6 is connected to the collector side of the transistor Q11. The other end of the resistor R6 is grounded. The base of the transistor Q11 is common-connected to the base of the transistor Q10 and to the bases of the transistors Q3 and Q4. That is, the transistors Q3, Q4, Q10 and Q11 configure a current mirror circuit. A voltage Vptat′ having a positive temperature coefficient is outputted from a connection point E located between the collector of the transistor Q11 and the resistor R6. The voltage Vptat′ is inputted to the non-inverting input terminal (+) of the op-amp OP1 of the subtracting circuit 38.

(Operation of Voltage Generating Circuit)

Next, the circuit operation of the voltage generating circuit 30 will be described.

Like the first exemplary embodiment, the collector currents of the transistors Q1 and Q2 of the first voltage source circuit 32 that has come to operate stably become such that the collector current I_{Q1}=the collector current I_{Q2} because of the current mirror circuit of the transistors Q3 and Q4. Further, because of the current mirror circuit comprising the transistors Q3, Q4, Q10 and Q11, the collector current of the transistor Q10 and the collector current of the transistor Q11 become equal to the collector current I_{Q1} of the transistor Q1.

In the second voltage source circuit 34, the collector current I_{Q1} of the transistor Q10 flows in the transistor Q9. The transistor Q9 is diode-connected, so the base-emitter voltage has a negative temperature coefficient. The base-emitter voltage of the transistor Q9 is outputted from the connection point D as the output voltage Vpn having a negative temperature coefficient.

In the third voltage source circuit 36, the collector current I_{Q1} of the transistor Q11 flows in the resistor R6. With respect to the output voltage Vptat having the positive temperature coefficient of the first exemplary embodiment, the voltage Vptat′ that can be set to an arbitrary positive temperature coefficient by the resistance ratio (R6/R1) is outputted from the connection point E as the output voltage Vptat′ having a positive temperature coefficient.

Next, in the subtracting circuit 38, the voltage Vptat′ having a positive temperature coefficient is inputted to the non-inverting input terminal (+) of the op-amp OP1. Further, the voltage Vpn having a negative temperature coefficient is inputted to the inverting input terminal (−) of the op-amp OP1. In accordance with expression (2) above, the output voltage Tout becomes a value that is equal to the difference between the voltage Vptat′ and the product of the resistance ratio (R8/R7) and the voltage Vpn.

As described above, in the voltage generating circuit 30 of the present exemplary embodiment, the positive temperature coefficient of the output voltage Tout can be arbitrarily set by adjusting the temperature coefficients of the input voltages Vptat′ and Vpn. Further, the value of the output voltage Tout can be arbitrarily set by adjusting the resistance ratio (R8/R7) such that the output voltage rises from 0 V in proportion to temperature.

In particular, in the present exemplary embodiment, the voltage Vpn that is the base-emitter voltage of the transistor Q9 can be stably generated by creating a current mirror circuit in which the bases of the transistors Q10 and Q11 are common-connected to the bases of the transistors Q1 and Q2 of the band-gap reference circuit. Further, the positive temperature coefficient of the voltage Vptat′ can be set to an arbitrary value by the resistance ratio (R6/R1) without considering the negative temperature coefficient of the transistor Q2 by connecting the resistor R6 to the collector of the transistor Q11. Setting of the positive temperature coefficient of the output voltage Tout also similarly becomes easy because adjustment of the temperature coefficient of the input voltage Vptat′ becomes easy.

### Third Exemplary Embodiment

### (Configuration of Voltage Generating Circuit)

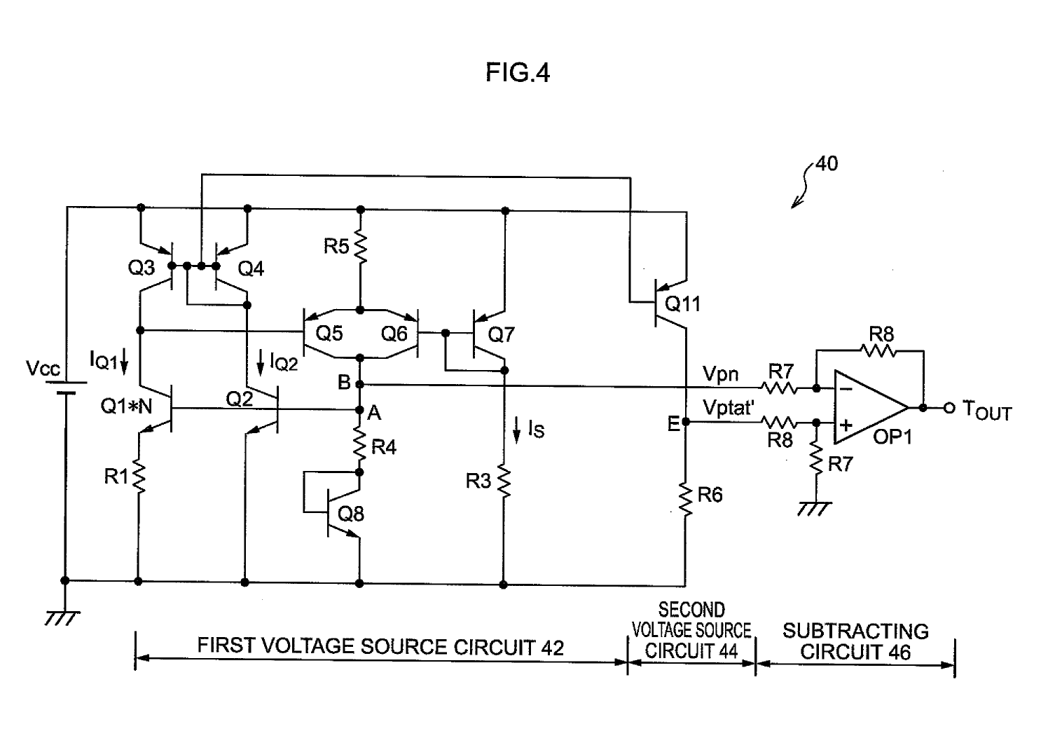

FIG. 4 is a circuit diagram showing the configuration of a voltage generating circuit 40 pertaining to a third exemplary embodiment of the present invention.

The voltage generating circuit 40 pertaining to the third exemplary embodiment is equipped with a first voltage source circuit 42 for generating a voltage having a negative temperature coefficient, a second voltage source circuit 44 that outputs a voltage having a positive temperature coefficient, and a subtracting circuit 46 into which a voltage Vptat′ from the second voltage source circuit 44 and a voltage Vpn from the first voltage source circuit 42 are inputted and which outputs a voltage Tout having a positive temperature coefficient. In the present exemplary embodiment, the second voltage source circuit 44 corresponds to a “first voltage source” and the first voltage source circuit 42 corresponds to a “second voltage source”.

The voltage generating circuit 40 pertaining to the third exemplary embodiment adds a configuration corresponding to the third voltage source circuit 36 of the second exemplary embodiment, omits the second voltage source circuit 24 of the first exemplary embodiment, and changes the circuit configuration of the first voltage source circuit 22, but in regard to configural portions that are the same as those in the voltage generating circuit 20 pertaining to the first exemplary embodiment and the voltage generating circuit 30 pertaining to the second exemplary embodiment, the same signs will be given thereto and some description thereof will be omitted.

The first voltage source circuit 42 is equipped with a configuration where the resistor R2 is removed from the first voltage source circuit 22 of the first exemplary embodiment. That is, the emitter side of the transistor Q2 is grounded, one end of the resistor R1 is connected to the emitter side of the transistor Q1, and the other end of the resistor R1 is grounded. By connecting in this manner, the base-emitter voltage of the transistor Q2 is outputted as a voltage Vpn′ having a negative temperature coefficient from the connection point B located between the collector of the transistor Q5 and the resistor R4. The voltage Vpn′ is inputted to the inverting input terminal (−) of the op-amp OP1 of the subtracting circuit 46.

The second voltage source circuit 44 is a circuit where the second voltage source circuit 24 of the first exemplary embodiment is removed and where a configuration corresponding to the third voltage source circuit 36 of the second exemplary embodiment is instead added. Specifically, the second voltage source circuit 44 is configured to be equipped with the PNP transistor Q11 and the resistor R6. One end of the resistor R6 is connected to the collector side of the transistor Q11. The other end of the resistor R6 is grounded.

The base of the transistor Q11 is common-connected to the bases of the transistors Q3 and Q4. That is, the transistors Q3, Q4 and Q11 configure a current mirror circuit. A voltage Vptat′ having a positive temperature coefficient is outputted from the connection point E located between the collector of the transistor Q11 and the resistor R6. The voltage Vptat′ is inputted to the non-inverting input terminal (+) of the op-amp OP1 of the subtracting circuit 46.

### (Operation of Voltage Generating Circuit)

Next, the circuit operation of the voltage generating circuit 40 will be described.

Like the first exemplary embodiment, the collector currents of the transistors Q1 and Q2 of the first voltage source circuit 42 that has come to operate stably become such that the collector current I_{Q1}=the collector current I_{Q2} because of the current mirror circuit of the transistors Q3 and Q4. Further, because of the current mirror circuit comprising the transistors Q3, Q4 and Q11, the collector current of the transistor Q11 becomes equal to the collector current I_{Q1} of the transistor Q1.

In the second voltage source circuit 42, the collector current I_{Q1} of the transistor Q4 flows in the transistor Q2. The base-emitter voltage of the transistor Q2 has a negative temperature coefficient. The base-emitter voltage of the transistor Q2 is outputted from the connection point B as the output voltage Vpn′ having a negative temperature coefficient.

In the second voltage source circuit 44, the collector current I_{Q1} of the transistor Q11 flows in the resistor R6. With respect to the output voltage Vptat having the positive temperature coefficient of the first exemplary embodiment, the voltage Vptat′ that can be set to an arbitrary positive temperature coefficient by the resistance ratio (R6/R1) is outputted from the connection point E as the output voltage Vptat′ having a positive temperature coefficient.

Next, in the subtracting circuit 46, the voltage Vptat′ having a positive temperature coefficient is inputted to the non-inverting input terminal (+) of the op-amp OP1. Further, the voltage Vpn′ having a negative temperature coefficient is inputted to the inverting input terminal (−) of the op-amp OP1. In accordance with expression (3) below, the output voltage Tout becomes a value that is equal to the difference between the voltage Vptat′ and the product of the resistance ratio (R8/R7) and the voltage Vpn′.

Tout=Vptat′−(R8/R7)*Vpn′ Expression (3)

As described above, in the voltage generating circuit 40 of the present exemplary embodiment, the positive temperature coefficient of the output voltage Tout can be arbitrarily set by adjusting the temperature coefficients of the input voltages Vptat′ and Vpn′. Further, the value of the output voltage Tout can be arbitrarily set by adjusting the resistance ratio (R8/R7) such that the output voltage rises from 0 V in proportion to temperature.

In particular, in the present exemplary embodiment, there becomes less consumed power during operation because the transistors and resistors are reduced, and the voltage Vptat′ having a positive temperature coefficient can be obtained in a lower voltage operation in comparison to the voltage Vptat of the first exemplary embodiment.

Further, like the second exemplary embodiment, the positive temperature coefficient of the voltage Vptat′ can be set to an arbitrary value by the resistance ratio (R6/R1) without considering the negative temperature coefficient of the transistor Q2 by connecting the resistor R6 to the collector of the transistor Q11. Setting of the positive temperature coefficient of the output voltage Tout also similarly becomes easy because adjustment of the temperature coefficient of the input voltage Vptat′ becomes easy.

### Fourth Exemplary Embodiment

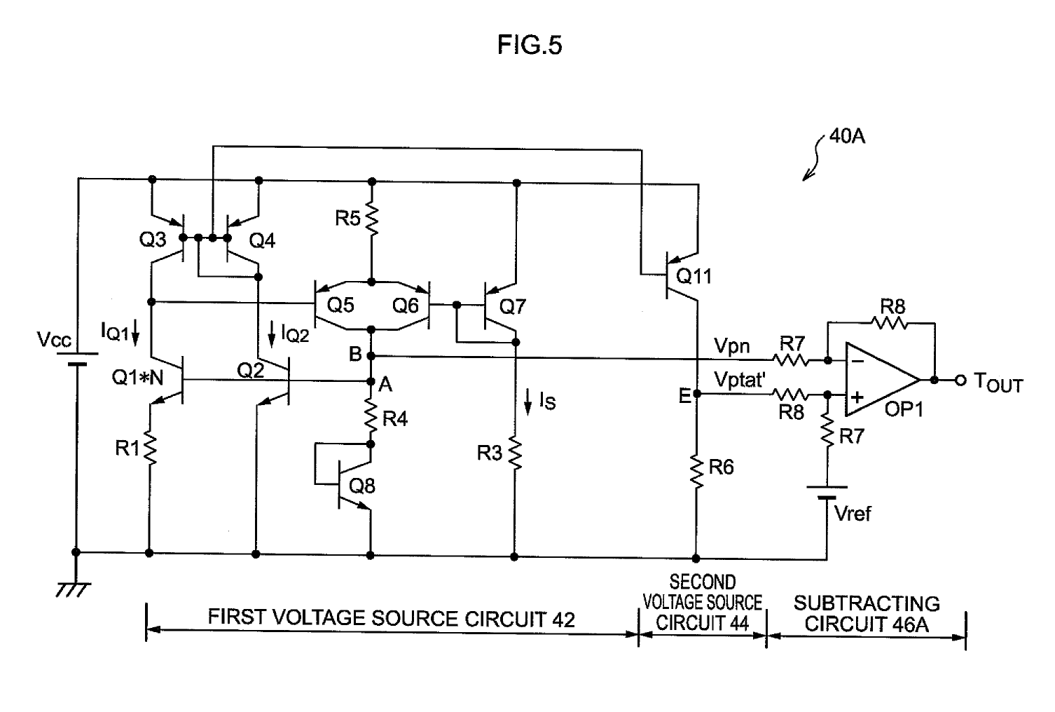

FIG. 5 is a circuit diagram showing the configuration of a voltage generating circuit 40A pertaining to a fourth exemplary embodiment.

The voltage generating circuit 40A pertaining to the fourth exemplary embodiment is a modification of the third exemplary embodiment and, like the voltage generating circuit 40, is equipped with the first voltage source circuit 42, the second voltage source circuit 44 and a subtracting circuit 46A. The voltage generating circuit 40A has the same configuration as that of the voltage generating circuit 40 pertaining to the third exemplary embodiment except that the reference potential=Vref≠0 V and one end of the resistor R7b (see FIG. 1) connected to the op-amp OP1 of the subtracting circuit 46A is connected to a constant potential terminal Vref that is a reference potential terminal. Consequently, in regard to configural portions that are the same as those in the voltage generating circuit 40, the same signs will be given thereto and some description thereof will be omitted.

The subtracting circuit 46A is, like the subtracting circuit 16 of the basic configuration shown in FIG. 1, configured as a differential amplifier including the op-amp OP1, the first resistor R7a, the second resistor R8a, the third resistor R8b and the fourth resistor R7b. The output voltage Vpn′ having a negative temperature coefficient that is outputted from the connection point B of the first voltage source circuit 42 is inputted to the inverting input terminal (−) of the op-amp OP1. The output voltage Vptat′ having a positive temperature coefficient that is outputted from the connection point E of the second voltage source circuit 44 is inputted to the non-inverting input terminal (+) of the op-amp ON.

Like the subtracting circuit 16 of the basic configuration, the op-amp OP1 is an ideal op-amp, and assuming that the input impedance is infinite (∞), when the output voltage of the op-amp OP1 is calculated under the condition of R7a=R7b=R7 and R8a=R8b=R8, the output voltage Tout′ is expressed by expression (4) below.

Tout′=Vptat′−(R8/R7)*Vpn′+(R8/R7)*Vref Expression (4)

When the output voltage Tout of the voltage generating circuit 40 expressed by expression (3) above is used, expression (4) above is transformed into expression (5) below. As will be understood from expression (5), the output voltage Tout′ of the voltage generating circuit 40A becomes a value that is equal to the sum of the output voltage Tout of the voltage generating circuit 40 pertaining to the third exemplary embodiment and a constant voltage proportional to the reference voltage Vref.

Tout′=Tout+(R8/R7)*Vref Expression (5)

As described above, in the voltage generating circuit 40A of the present exemplary embodiment, effects that are the same as those of the voltage generating circuit 40 pertaining to the third exemplary embodiment are obtained, and the output voltage Tout′ that is equal to the sum of the output voltage Tout of the voltage generating circuit 40 and a constant voltage proportional to the reference voltage Vref can be obtained. The reference voltage Vref does not have a temperature coefficient, so the value of the output voltage Tout′ can be arbitrarily set while maintaining the positive temperature coefficient of the output voltage Tout.

In the exemplary embodiments described above, voltage generating circuits have been described, but because the voltage generating circuits described above can output a voltage having a positive temperature coefficient and can arbitrarily set the positive temperature coefficient, they can be used as temperature detectors such as temperature gauges and also as temperature detecting circuits and temperature compensating circuits of semiconductor integrated circuits. Further, because the output voltage can be arbitrarily set so as to rise from 0 V in proportion to temperature, the voltage generating circuits can be widely utilized as detecting devices that detect characteristics having temperature dependence.

What is claimed is:

1. A voltage generating circuit comprising:
a first voltage source that outputs a first voltage having a positive temperature coefficient;
a second voltage source that outputs a second voltage having a negative temperature coefficient; and
a subtracting circuit that is configured as a differential amplifier including an op-amp and four resistors, with an inverting input terminal of the op-amp being connected to the second voltage source via a first resistor, a second resistor being connected between the inverting input terminal and an output terminal of the op-amp, a non-inverting input terminal of the op-amp being connected to the first voltage source via a third resistor of the same size as the second resistor, the non-inverting input terminal of the op-amp being connected to a reference potential terminal via a fourth resistor of the same size as the first resistor, the first voltage from the first voltage source and the second voltage from the second voltage source being inputted to the subtracting circuit, and the subtracting circuit outputting a third voltage having a positive temperature coefficient.

2. The voltage generating circuit according to claim 1, wherein the first resistor, the second resistor, the third resistor and the fourth resistor are variable resistors, and weightings of the first voltage and the second voltage inputted to the subtracting circuit are different.

3. The voltage generating circuit according to claim 1, wherein the reference potential terminal is a ground terminal or a constant potential terminal.

4. The voltage generating circuit according to claim 1, wherein
the first voltage source is configured by a voltage source circuit that outputs a voltage having a positive temperature coefficient proportional to a thermal voltage or by another voltage source circuit that outputs a voltage expressed by a sum of a forward voltage of a diode and the voltage having the positive temperature coefficient proportional to the thermal voltage, and
the second voltage source is configured by a voltage source circuit that is equipped with a diode connection and outputs a voltage having a negative temperature coefficient generated by the diode.
